(19) United States
(12) Patent Application Publication
(10) Pub. No.: US 2026/0082121 A1
(43) Pub. Date: Mar. 19, 2026

(54) ELECTRONIC DEVICE AND OPERATING METHOD THEREFOR, AND STORAGE MEDIUM

(71) Applicant: SHENZHEN MICROBT ELECTRONICS TECHNOLOGY CO., LTD., SHENZHEN, GUANGDONG (CN)

(72) Inventors: Yong LI, SHENZHEN, GUANGDONG (CN); Guo AI, SHENZHEN, GUANGDONG (CN); Zuoxing YANG, SHENZHEN, GUANGDONG (CN)

(73) Assignee: SHENZHEN MICROBT ELECTRONICS TECHNOLOGY CO., LTD., SHENZHEN, GUANGDONG (CN)

(21) Appl. No.: 19/106,486

(22) PCT Filed: Jan. 10, 2024
(86) PCT No.: PCT/CN2024/071590

§ 371 Date: Feb. 25, 2025

(30) Foreign Application Priority Data
Apr. 10, 2023 (CN) 202310401687.9

(51) Int. Cl. H04N 23/65; G06V 20/40; G06V 20/70; H04N 23/61; H04N 23/667

(52) U.S. Cl. CPC H04N 23/651; G06V 20/44; G06V 20/70; H04N 23/61; H04N 23/667

(57) ABSTRACT

Please replace the Abstract with the following:

An electronic device and an operating method therefor, and a storage medium are provided. A method of operating an electronic device includes when operating the electronic device in a first operation mode: causing the electronic device to be in a first state in which a pre-roll module captures and records a video; causing the electronic device to enter a second state in response to an event being detected in which a camera module captures and records a video; determining whether a current image frame of the video captured by the camera module contains a target in response to a preset period of time having elapsed since the event is detected; causing the electronic device to be maintained in the second state in response to the target being contained; causing the electronic device to enter the first state in response to the target being not contained.

### CROSS-REFERENCE TO RELATED APPLICATIONS

This application is a national stage of International Application No. PCT/CN2024/071590, filed on Jan. 10, 2024, which claims priority to Chinese Patent Application No. 202310401687.9, filed on Apr. 10, 2023. Both of the aforementioned applications are hereby incorporated by reference in their entireties.

### TECHNICAL FIELD

The present disclosure relates to the field of video surveillance, and more specifically, to an electronic device using a battery-powered camera, a method of operating the same, and a storage medium.

### BACKGROUND

Video surveillance devices using battery-powered cameras always have to strike a balance between performance and power consumption. Continuous Video Recording (CVR) is desirable in providing comprehensive video surveillance data, but the power consumption level required by CVR is often daunting for video surveillance devices that use battery-powered cameras. As a result, an increasing number of video surveillance devices that use battery-powered cameras are designed as Event-based Video Recording (EVR). EVR does not record videos all day like CVR, but only records video clips associated with detection of specific events (such as motion events or sound events), which makes the power consumption level required by EVR much lower than that required by CVR, thus making it more suitable for video surveillance devices that use battery-powered cameras.

### SUMMARY

According to a first aspect of the present disclosure, a method of operating an electronic device is provided. The electronic device includes a battery, a camera module, and a pre-roll module. The battery is configured to supply power to the electronic device. The camera module is configured to capture a video. The pre-roll module is configured to capture a video at lower power consumption compared to the camera module. The method includes when operating the electronic device in a first operation mode: causing the electronic device to be in a first state by default, wherein in the first state, the camera module is deactivated, and the pre-roll module is activated to capture and record a video; causing the electronic device to enter a second state from the first state in response to an event being detected, wherein in the second state, the camera module is activated to capture and record a video; determining whether a current image frame of the video captured by the camera module contains a target in response to a preset period of time having elapsed since the event is detected; causing the electronic device to be maintained in the second state in response to determining that the current image frame of the video captured by the camera module contains the target; causing the electronic device to enter the first state from the second state in response to determining that the current image frame of the video captured by the camera module does not contain the target.

According to a second aspect of the present disclosure, an electronic device is provided. The electronic device includes: a battery configured to supply power to the electronic device; a camera module configured to capture a video; a pre-roll module configured to capture a video at lower power consumption compared to the camera module; one or more processors; and a memory storing computer-executable instructions, the computer-executable instructions, when executed by the one or more processors, causing the one or more processors to perform the method of operating an electronic device according to the first aspect of the present disclosure.

According to a third aspect of the present disclosure, a non-transitory storage medium storing computer-executable instructions thereon is provided. The computer-executable instructions, when executed by one or more processors, cause the one or more processor to perform the method of operating an electronic device according to the first aspect of the present disclosure. The electronic device includes a battery, a camera module, and a pre-roll module. The battery is configured to supply power to the electronic device. The camera module is configured to capture a video. The pre-roll module is configured to capture a video at lower power consumption compared to the camera module.

Further features and advantages of the present disclosure will become more apparent from the following detailed description of exemplary embodiments of the present disclosure with reference to the accompanying drawings.

### BRIEF DESCRIPTION OF THE DRAWINGS

The accompanying drawings that constitute a part of the description illustrate embodiments of the present disclosure and, together with the description, serve to explain the principle of the present disclosure.

The present disclosure can be understood more clearly according to the following detailed description with reference to the accompanying drawings.

FIG. 1 is a schematic block diagram that illustrates a non-limiting example of a system upon which one or more embodiments of the present disclosure may be implemented, where the system includes an electronic device according to some embodiments of the present disclosure.

FIG. 2 is a flowchart that illustrates a first operation mode of an electronic device according to some embodiments of the present disclosure.

FIG. 3 is a flowchart that illustrates a second operation mode of an electronic device according to some embodiments of the present disclosure.

FIG. 4 is a flowchart that illustrates a second operation mode of an electronic device according to some other embodiments of the present disclosure.

FIG. 5 is a flowchart that illustrates a third operation mode of an electronic device according to some embodiments of the present disclosure.

FIG. 6 is a flowchart that illustrates a fourth operation mode of an electronic device according to some embodiments of the present disclosure.

FIG. 7 is a flowchart that illustrates a fifth operation mode of an electronic device according to some embodiments of the present disclosure.

FIG. 8 is a flowchart that illustrates a non-limiting example of a mode switching mechanism of an electronic device according to some embodiments of the present disclosure.

Note that in the implementations described below, sometimes the same reference signs are commonly used in different accompanying drawings to represent the same parts or parts with the same functions, and the repeated description thereof is omitted. In the description, similar numbers and letters are used to represent similar items. Therefore, once an item is defined in an accompanying drawing, the item in subsequent accompanying drawings will not be further discussed.

For ease of understanding, positions, dimensions, ranges, and the like of structures shown in the accompanying drawings and the like sometimes do not represent actual positions, dimensions, ranges, and the like. Therefore, the disclosed invention is not limited to the positions, dimensions, ranges, and the like disclosed in the accompanying drawings and the like. Moreover, the accompanying drawings are not necessarily drawn to scale, and some features may be exaggerated to show the details of specific components.

### DETAILED DESCRIPTION

The following describes in detail various exemplary embodiments of the present disclosure with reference to the accompanying drawings. It should be noted that, unless specified otherwise, relative arrangements of components and steps, numerical expressions and values set forth in the embodiments do not limit the scope of the present disclosure.

The following descriptions of at least one exemplary embodiment is actually only illustrative and does not constitute any limitation on the present disclosure or its application or use. Those skilled in the art will understand that they only illustrate the exemplary manner for implementing the present disclosure, rather than exhaustive manners.

Techniques, methods and devices known to those having ordinary skills in the related art may not be discussed in detail, but in appropriate cases, the techniques, methods and devices should be considered as part of the description.

An EVR device can save power by keeping recording and/or processing components, which are normally in a high-power state, in a low-power state until an event is detected. However, after an event is detected, these recording and/or processing components need to first spend time entering from the low-power state to the high-power state so that they can operate normally. This delay may result in missing contents related to an important activity that causes the EVR device to detect the event in a video clip associated with the event recorded by the EVR device. In addition, since the EVR device starts to record the video after the event is detected, the important activity may have occurred before the EVR device detects the event, which cannot be recorded by the EVR device. In contrast, a CVR device does not miss key information due to the ability to record videos throughout the day. However, the CVR device consumes too much power and generates a large amount of junk data that users do not care about, which not only occupies storage space but also causes trouble for users to search for data of interest.

The present disclosure provides an electronic device, which can be powered by a battery and include a camera module configured to capture a video and a pre-roll module configured to capture a video at lower power consumption compared to the camera module. The camera module may be configured for event-based recording, and the pre-roll module can perform cyclic recording alone in a low power consumption mode when the camera module is powered off. This enables a video clip recorded by the pre-roll module during a period of time before an event is detected to be attached before a video clip associated with the detected event recorded by the camera module, thereby allowing users to have a clearer understanding of a context of the event. Such electronic device neither consumes too much power nor generates a large amount of junk data, nor is it prone to missing key information, thus extending the battery usage life and improving the user experience while meeting the user need.

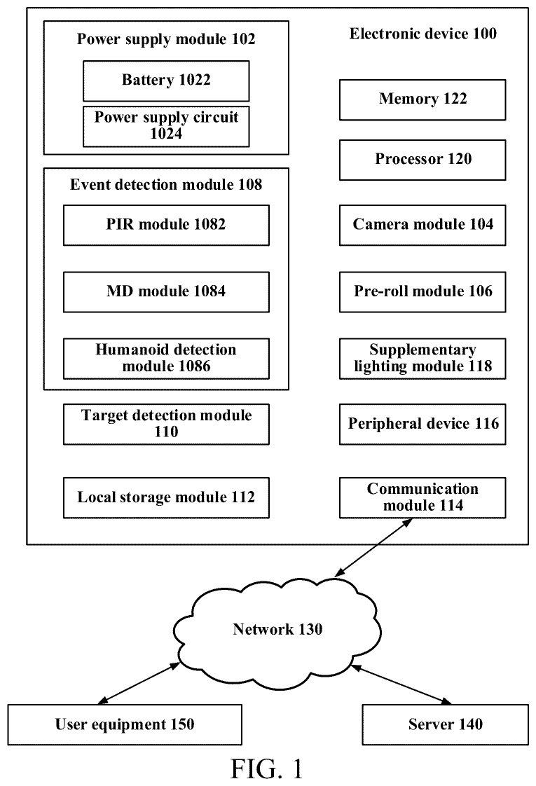

FIG. 1 illustrates a schematic block diagram of a non-limiting example of a system upon which one or more embodiments of the present disclosure may be implemented. The system includes an electronic device 100 according to some embodiments of the present disclosure, and further includes a network(s) 130, a server(s) 140, and a user equipment(s) 150. The electronic device 100 may communicate with the server 140 via the network 130. For example, the electronic device 100 may transmit data to the server 140 for processing and/or storage. The electronic device 100 may also communicate with the user equipment 150 via the network 130. For example, the electronic device 100 may receive a command of a user from the user equipment 150 or transmit data to the user equipment 150 for viewing by the user. For the purpose of non-limiting illustration, in an example application scenario, the electronic device 100 may be a smart doorbell, the user equipment 150 may be a user terminal such as a smartphone or a personal computer of the user, and the server 140 may be a cloud platform.

Referring to FIG. 1, the electronic device 100 may include a battery 1022, a camera module 104, and a pre-roll module 106. The battery 1022 is configured to supply power to the electronic device 100. The camera module 104 is configured to capture a video. The pre-roll module 106 is configured to capture a video at lower power consumption compared to the camera module 104. For example, the camera module 104 may include a high-power-consumption recording chip and an image sensor, and the pre-roll module 106 may include a low-power-consumption recording chip and an image sensor. The electronic device 100 can support a function of switching on and off the modules separately, so that it can achieve different power consumption levels by differently controlling the powering on and powering off of the modules in different operation modes.

In some embodiments, the electronic device 100 may include a power supply module 102. The power supply module 102 may include a power supply circuit 1024 in addition to the battery 1022. The power supply circuit 1024 may be configured to be connected to an external power supply to power the electronic device 100 by using power from the external power supply. In some examples, when the battery 1022 is a rechargeable battery, the power supply circuit 1024 may also be configured to charge the battery 1022 by using the power from the external power supply.

In some embodiments, the electronic device 100 may include an event detection module 108. Through the collaboration of the event detection module 108 and the camera module 104, the electronic device 100 can be provided with EVR capability. The event detection module 108 may be configured to be capable of detecting different types of events. In the embodiment illustrated in FIG. 1, the event detection module 108 includes a passive infrared (PIR) module 1082, a motion detection (MD) module 1084, and a humanoid detection module 1086. For example, the PIR module 1082 may detect a PIR event by detecting a change in infrared radiation level, the MD module 1084 may detect a motion event by comparing a pixel change between consecutive image frames in conjunction with a motion detection algorithm, and the humanoid detection module 1086 may detect a humanoid event by analyzing whether an image frame contains a humanoid shape through an intelligent algorithm such as an image recognition or classification algorithm. These are only non-limiting example implementations of the PIR module 1082, the MD module 1084, and the humanoid detection module 1086. It should be understood that any suitable method known now or developed in the future may also be used to detect events. In some examples, the event detection sensitivity level of the event detection module 108 is configurable, e.g., among three levels “high”, “medium”, and “low”, and may be configured as “medium” by default. Alternatively, in some embodiments, the electronic device 100 may not be equipped with the event detection module 108 itself but communicate with an event detection device external to the electronic device 100. The external event detection device may notify the electronic device 100 to activate the camera module 104 to start recording when an event is detected.

In some embodiments, the electronic device 100 may include a target detection module 110 which may be configured to detect whether a current image frame of a video captured by the camera module 104 contains a target (for example, person, pet, article, etc.). For example, the target detection module 110 may analyze whether an image frame contains the target through an intelligent algorithm such as an image recognition or classification algorithm. Through the collaboration of the target detection module 110 and the camera module 104, the electronic device 100 can make a complete record of an event. For example, after the camera module 104 starts to record a video in response to an event being detected, the target detection module 110 may periodically determine whether a current image frame of the video captured by the camera module 104 contains a target. If it is determined that the current image frame contains the target, the camera module 104 is caused to continue recording. If it is determined that the current image frame does not contain the target, the camera module 104 is caused to stop recording. In this way, the camera module 104 can record the complete context of the event. Alternatively, in some embodiments, the electronic device 100 may not be equipped with the target detection module 110 itself but communicate with a target detection device external to the electronic device 100. The electronic device 100 may transmit the image frame of the video captured by the camera module 104 to the external target detection device, and the target detection device may notify the electronic device 100 to deactivate the camera module 104 to stop recording when it is determined that the image frame does not contain the target.

In some embodiments, the electronic device 100 may include a local storage module 112 which may be configured to store the video recorded by the camera module 104 and/or pre-roll module 106 locally. The local storage module 112 may be in the form of, for example, but not limited to, a Transflash (TF) card or an embedded multimedia card (eMMC). Alternatively, in some other embodiments, the electronic device 100 may not be equipped with the local storage module 112 itself but communicate with a local storage device external to the electronic device 100. Additionally or alternatively, in some embodiments, the electronic device 100 may also store the video recorded by the camera module 104 and/or pre-roll module 106 on the cloud via a communication module 114 of the electronic device 100. For example, the server 140 may be a cloud platform that provides cloud storage services.

In some embodiments, the electronic device 100 may include peripheral devices 116 such as, but not limited to, a speaker, a microphone, and the like, to provide additional functions. In some embodiments, to achieve better video effects, the electronic device 100 may also have a video capture assisting function. For example, the electronic device 100 may include a supplementary lighting module 118 for supplementary lighting during video capture. The supplementary lighting module 118 can provide illumination at various brightness levels of one or more wavelengths or wavelength ranges, for example. Alternatively, in some embodiments, the electronic device 100 may not be equipped with the supplementary lighting module 118 itself but communicate with a supplementary lighting device external to the electronic device 100. The external supplementary lighting device may perform supplementary lighting in response to a supplementary lighting request received from the electronic device 100.

The electronic device 100 may further include a processor(s) 120 and a memory 122 storing computer-executable instructions. The computer-executable instructions, when executed by the processor 120, cause the processor 120 to perform a method of operating the electronic device 100. The processor 120 may be, for example, a Central Processing Unit (CPU) of the electronic device 100. The processor 120 may be any type of general-purpose processor, or it may be a processor specifically designed to operate the electronic device 100, such as an Application Specific Integrated Circuit (ASIC). The memory 122 may include various computer-readable media accessible by the processor 120. In various embodiments, the memory 122 described herein may include volatile and non-volatile media, and removable and non-removable media. For example, the memory 122 may include any combination of the following: Random Access Memory (RAM), Dynamic RAM (DRAM), Static RAM (SRAM), Read Only Memory (ROM), flash memory, cache memory, and/or any other type of non-transitory computer-readable media. The memory 122 may store instructions that, when executed by the processor 120, cause the processor 120 to perform the method of operating the electronic device 100.

The electronic device 100 may have one or more operation modes. The method of operating the electronic device 100 according to various embodiments of the present disclosure will be described below in detail with reference to the accompanying drawings.

### (1) First Operation Mode (Long Online Mode)

When the electronic device 100 is operated in a first operation mode, the electronic device 100 may be operated by: causing the electronic device 100 to be in a first state by default, wherein in the first state, the camera module 104 is deactivated, and the pre-roll module 106 is activated to capture and record a video; causing the electronic device 100 to enter a second state from the first state in response to an event being detected, wherein in the second state, the camera module 104 is activated to capture and record a video; determining whether a current image frame of the video captured by the camera module 104 contains a target (for example, person, pet, article, etc.) in response to a preset period of time (for example, X seconds, where X is configurable by the user) having elapsed since the event is detected; causing the electronic device 100 to be maintained in the second state in response to determining that the current image frame of the video captured by the camera module 104 contains the target; causing the electronic device 100 to enter the first state from the second state in response to determining that the current image frame of the video captured by the camera module 104 does not contain the target. In some examples, after causing the electronic device 100 to be maintained in the second state in response to determining that the current image frame of the video captured by the camera module 104 contains the target, a preset period of time may be waited for to redetermine whether a current image frame of the video captured by the camera module 104 contains the target. In this way, whether the condition for the camera module 104 to stop recording is met is determined once every preset period of time.

That is to say, in the first operation mode: the pre-roll module 106 may perform cyclic recording in a low power consumption mode when no event is detected; after an event is detected, the camera module 104 may perform continuous video recording until there is no target in the image. This first operation mode is also referred to as long online mode herein. In some examples, the video recorded by the camera module 104 and the video of a preset duration recorded by the pre-roll module 106 immediately before the event is detected may be stored by means of local storage (for example, the local storage module 112) and/or cloud storage (for example, the server 140). Assuming that the pre-roll module 106 has recorded a video of 5 seconds before the event is detected, and the camera module 104 has totally recorded a video of N seconds associated with the event, a video of (N+5) seconds may be finally stored locally and/or on the cloud. In some examples, a minimum recording time for the camera module 104 after an event is detected may be set. For example, the camera module 104 may required to record a video of at least 10 seconds.

In some examples, the causing the electronic device 100 to enter a second state from the first state in response to an event being detected may include: detecting whether an event of a second type different from a first type occurs in response to an event of the first type being detected, and causing the electronic device 100 to enter the second state from the first state in response to the event of the second type being detected. In some examples, the causing the electronic device 100 to enter a second state from the first state in response to an event being detected may include: detecting whether an event of a second type different from a first type occurs and detecting whether an event of a third type different from the first type and the second type occurs in response to an event of the first type being detected, and causing the electronic device 100 to enter the second state from the first state in response to the event of the second type being detected and the event of the third type being detected. That is to say, multiple verification may be set for event detection to reduce the probability of misreport. For example, the event of the first type, the event of the second type, and the event of the third type may be selected from a group including: a PIR event, a motion event, a humanoid event, and a sound event. In some examples, the event of the first type is a PIR event, and the event of the second type and the event of the third type are selected from a group consisting of a motion event and a humanoid event. In addition, when the electronic device 100 has multiple event detection modules, such as the PIR module 1082, the MD module 1084, and the humanoid detection module 1086 as shown in FIG. 1, the PIR module 1082 may be activated by default, and the MD module 1084 and the humanoid detection module 1086 may be deactivated by default to save power. After the PIR module 1082 detects a PIR event, the MD module 1084 and the humanoid detection module 1086 may be activated for multiple verification.

In the first operation mode, the electronic device 100 may also support remote active wake-up in addition to passive wake-up by event. In some examples, when operating the electronic device 100 in the first operation mode, the camera module 104 may be activated to capture a video in response to a wake-up command from the user equipment 150 communicating with the electronic device 100 being received, and the video captured by the camera module 104 may be streamed to the user equipment 150 for viewing by a user. The wake-up command may be a viewing request of the user to view a current surveillance image of the electronic device 100 in real time. The communication module 114 may stream the video captured by the camera module 104 in real time to the user equipment 150 in response to the user's viewing request. The wake-up command may also be a playback request of the user to play back a past surveillance image of the electronic device 100. The communication module 114 may stream the video (for example, stored in the local storage module 112) previously captured by the camera module 104 to the user equipment 150 in response to the user's playback request. Regardless of whether the electronic device 100 is in the first state or the second state, the electronic device 100 may always support remote active wake-up.

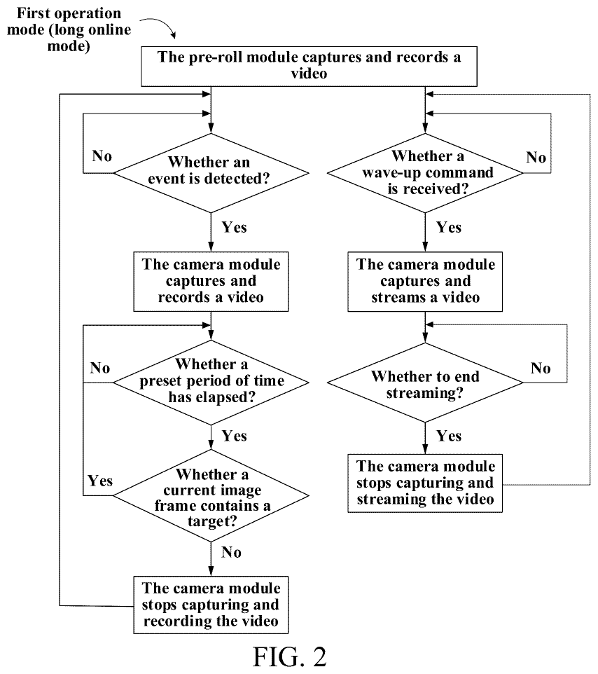

As an example, FIG. 2 illustrates a process of operating the electronic device 100 in the first operation mode. In this case, the electronic device 100 supports pre-roll, passive wake-up by event, and remote active wake-up. Specifically, the electronic device 100 is in the first state by default, in which the pre-roll module continuously captures and records a video (for example, a low-resolution video). On the one hand, upon an event is detected, the camera module starts to capture and record a video (for example, a high-resolution video). Next, whether a current image frame captured by the camera module contains a target is determined once every preset period of time. If the target is contained, the camera module continues to capture and record the video. If the target is not contained, the camera module stops capturing and recording the video. On the other hand, upon a wake-up command is received, for example, a user's viewing request is received, the camera module starts to capture and stream a video. Once it is determined to end streaming, for example, a user's request to end viewing is received, the camera module stops capturing and streaming the video. In some examples, the pre-roll module may always continuously capture and record the video regardless of whether the electronic device 100 is in the first state or the second state. In some other examples, the pre-roll module may continuously capture and record the video when the electronic device 100 is in the first state, and pause operation when the electronic device 100 is in the second state.

### (2) Second Operation Mode (Normal Power Mode)

When the electronic device 100 is operated in a second operation mode, the electronic device 100 may be operated by: causing the electronic device 100 to be in a third state by default, wherein in the third state, the pre-roll module 106 is deactivated, the camera module 104 is activated to capture a video, and the most recent video of a preset duration (for example, X seconds, where X is configurable by the user) is dynamically cached; causing the electronic device 100 to enter a fourth state from the third state in response to an event being detected, wherein in the fourth state, the camera module 104 is activated to capture and record a video; determining whether a current image frame of the video captured by the camera module 104 contains a target in response to a preset period of time having elapsed since the event is detected; causing the electronic device 100 to be maintained in the fourth state in response to determining that the current image frame of the video captured by the camera module 104 contains the target; causing the electronic device 100 to enter the third state from the fourth state in response to determining that the current image frame of the video captured by the camera module 104 does not contain the target. In some examples, after causing the electronic device 100 to be maintained in the fourth state in response to determining that the current image frame of the video captured by the camera module 104 contains the target, a preset period of time may be waited for to redetermine whether the current image frame of the video captured by the camera module 104 contains the target. In this way, whether the condition for the camera module 104 to stop recording is met is determined once every preset period of time.

That is to say, in the second operation mode: when no event is detected, the camera module 104 may also perform continuous video recording, but not all the videos are saved, only the most recent video is dynamically cached, and for example, only a main stream of the most recent 5 seconds is cached; after an event is detected, the camera module 104 may perform continuous video recording until there is no target in the image. Since the camera module 104 performs continuous video recording in the second operation mode regardless of whether an event is detected or not, in some examples, when the electronic device 100 is operated in the second operation mode, the user may be notified via the user equipment 150 communicating with the electronic device 100 to connect the electronic device 100 to an external power supply to power the electronic device 100 through the external power supply. This second operation mode is also referred to as normal power mode herein.

In some examples, the video recorded by the camera module 104 and the video dynamically cached immediately before the event is detected may be stored by means of local storage (for example, the local storage module 112) and/or cloud storage (for example, the server 140). Assuming that a main stream of the most recent 5 seconds has been dynamically cached, and the camera module 104 has totally recorded a video of N seconds associated with the event, a video of (N+5) seconds may be finally stored locally and/or on the cloud. In some examples, a minimum recording time for the camera module 104 after an event is detected may be set. For example, the camera module 104 may be required to record a video of at least 10 seconds.

In the second operation mode, multiple verification may also be set for event detection as in the first operation mode to reduce the probability of misreport. In addition, in the second operation mode, the electronic device 100 may also support remote active wake-up in addition to passive wake-up by event. In some examples, when operating the electronic device 100 in the second operation mode, the camera module 104 may be activated to capture a video in response to a wake-up command from the user equipment 150 communicating with the electronic device 100 being received, and the video captured by the camera module 104 may be streamed to the user equipment 150 for viewing by a user. The wake-up command may be a viewing request of the user to view a current surveillance image of the electronic device 100 in real time. The communication module 114 may stream the video captured by the camera module 104 in real time to the user equipment 150 in response to the user's viewing request. The wake-up command may also be a playback request of the user to play back a past surveillance image of the electronic device 100. The communication module 114 may stream the video (for example, stored in the local storage module 112) previously captured by the camera module 104 to the user equipment 150 in response to the user's playback request.

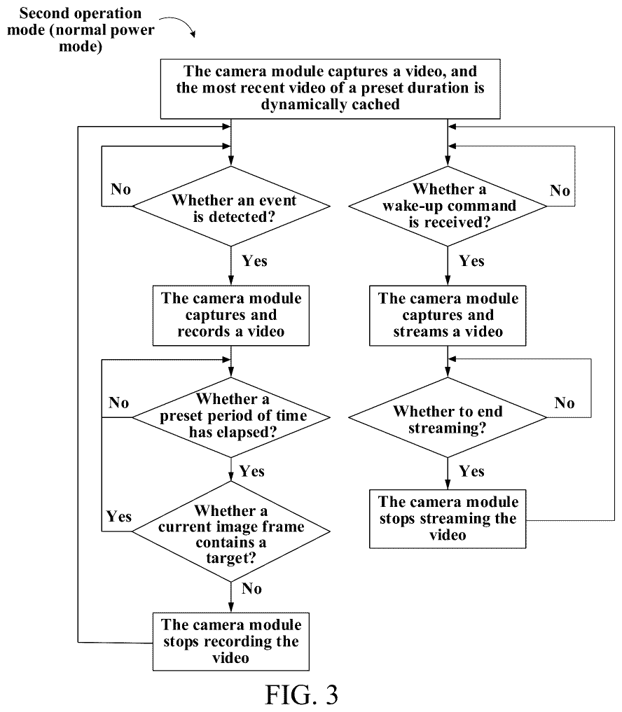

As an example, FIG. 3 illustrates a process of operating the electronic device 100 in the second operation mode. In this case, except for not enabling the pre-roll function, all functions and peripheral devices of the electronic device 100 are maintained in a normal working state, and it also supports both passive wake-up by event and remote active wake-up. Specifically, the electronic device 100 is in the third state by default, in which the video is captured by the camera module, and the electronic device 100 dynamically caches the most recent video of a preset duration. On the one hand, upon an event is detected, the camera module starts to capture and record a video. Next, whether a current image frame captured by the camera module contains a target is determined once every preset period of time. If the target is contained, the camera module continue to capture and record the video. If the target is not contained, the camera module stops recording the video. On the other hand, once a wake-up command is received, for example, a user's viewing request is received, the camera module starts to capture and stream a video. Once it is determined to end streaming, for example, a user's request to end viewing is received, the camera module stops streaming the video.

The second operation mode (normal power mode) may also have another implementation. Specifically, the electronic device 100 may be caused to be in a third state by default, wherein in the third state, the pre-roll module 106 is deactivated, the camera module 104 is activated to continuously capture and record a video, and the video recorded by the camera module is stored locally (for example, via the local storage module 112); an image frame corresponding to a moment at which an event is detected is labeled in the locally stored video to indicate the occurrence of the event in response to the event being detected. For example, whether a current image frame of the video captured by the camera module 104 contains a target may also be determined in response to a preset period of time having elapsed since the event is detected; the current image frame is labeled in the locally stored video to indicate the end of the event in response to determining that the current image frame of the video captured by the camera module 104 does not contain the target. In some examples, in response to determining that the current image frame of the video captured by the camera module 104 contains the target, a preset period of time may be waited for to redetermine whether the current image frame of the video captured by the camera module 104 contains the target. In this way, whether the condition for adding a label to indicate the end of the event is met is determined once every preset period of time.

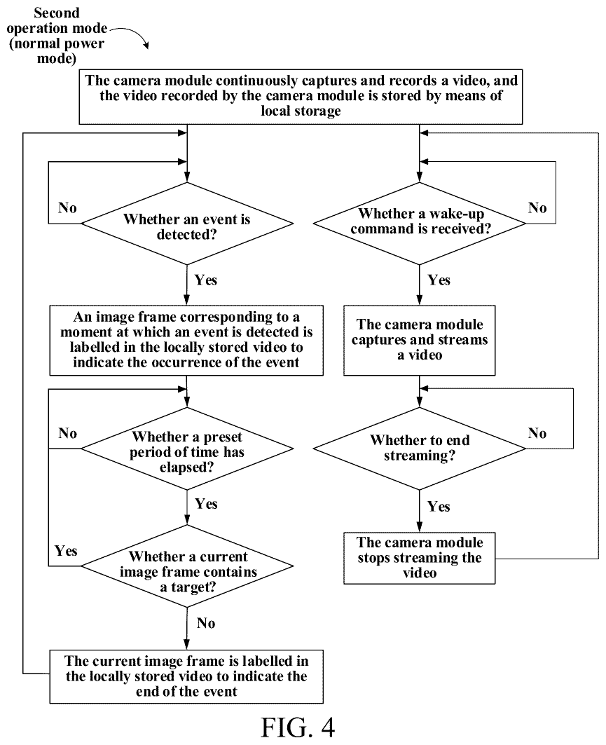

As an example, FIG. 4 illustrates a process of operating the electronic device 100 in this implementation of the second operation mode. In this case, except for not enabling the pre-roll function, all functions and peripheral devices of the electronic device 100 are maintained in a normal working state, and it also supports both passive wake-up by event and remote active wake-up. Specifically, the electronic device 100 is in a third state by default, in which the camera module continuously captures and records a video, and the video recorded by the camera module is stored locally. On the one hand, upon an event is detected, an image frame corresponding to a moment at which the event is detected is labeled in the locally stored video to indicate the occurrence of the event. Next, whether a current image frame captured by the camera module contains a target is determined once every preset period of time. If the target is not contained, the current image frame is labeled in the locally stored video to indicate the end of the event. On the other hand, upon a wake-up command is received, for example, a user's viewing request is received, the camera module starts to capture and stream a video. Once it is determined to end streaming, for example, a user's request to end viewing is received, the camera module stops streaming the video.

### (3) Third Operation Mode (Sleep Wake-Up Mode)

When the electronic device 100 is operated in a third operation mode, the electronic device 100 may be operated by: causing the electronic device 100 to be in a fifth state by default (sleep keep-alive state), wherein in the fifth state, the camera module 104 is deactivated, and the pre-roll module 106 is deactivated; causing the electronic device 100 to enter a sixth state from the fifth state in response to an event being detected, wherein in the sixth state, the camera module 104 is activated to capture and record a video; determining whether a current image frame of the video captured by the camera module 104 contains a target in response to a preset period of time having elapsed since the event is detected; causing the electronic device to be maintained in the sixth state in response to determining that the current image frame of the video captured by the camera module 104 contains the target; causing the electronic device 100 to enter the fifth state from the sixth state in response to determining that the current image frame of the video captured by the camera module 104 does not contain the target, or in response to determining that a duration for which the electronic device 100 is maintained in the sixth state exceeds a preset duration threshold. In some examples, after causing the electronic device 100 to be maintained in the sixth state in response to determining that the current image frame of the video captured by the camera module 104 contains the target, a preset period of time may be waited for to redetermine whether a current image frame of the video captured by the camera module 104 contains the target. In this way, whether the condition for the camera module 104 to stop recording is met is determined once every preset period of time. In addition, a maximum recording time (i.e., the preset duration threshold mentioned above) for the camera module 104 after an event is detected may be set. For example, the camera module 104 may be required to record a video of up to Y seconds (Y is configurable by the user, such as Y=30) before stopping recording.

That is to say, in the third operation mode: when no event is detected, neither the camera module 104 nor the pre-roll module 106 operates; after an event is detected, the camera module 104 may perform continuous video recording until there is no target in the image or until the preset duration threshold is exceeded. Since the electronic device 100 is maintained in the sleep keep-alive state unless awakened in the third operation mode, this third operation mode is also referred to as sleep wake-up mode herein.

In some examples, when operating the electronic device 100 in the third operation mode, the electronic device 100 may be maintained in the fifth state for a preset silent period of time after causing the electronic device 100 to enter the fifth state from the sixth state. During the preset silent period of time, event detection is not performed (for example, the event detection module 108 is deactivated). A duration of the preset silent period of time may be specifically configured according to the need. For example, it may be within 30 minutes, or within 15 minutes, or within 5 minutes, such as 1 minute.

In the third operation mode, multiple verification may also be set for event detection as in the first operation mode to reduce the probability of misreport. Of course, only events of one or a few types may be detected to save power. For example, only the PIR module 1082 is activated, while the MD module 1084 and the humanoid detection module 1086 are not activated. In addition, in the third operation mode, the electronic device 100 may also support remote active wake-up in addition to passive wake-up by event. The electronic device 100 may support remote active wake-up during a non-silent period of time, but not support remote active wake-up during the silent period of time. In some other examples, the electronic device 100 may support remote active wake-up during both the silent period of time and the non-silent period of time. For example, during the preset silent period of time, the camera module 104 may be activated to capture a video in response to a wake-up command from the user equipment 150 communicating with the electronic device 100 being received, and the video captured by the camera module 104 is streamed to the user equipment 150 for viewing by a user. The embodiments regarding the wake-up command are similar to the above, which will not be repeated here.

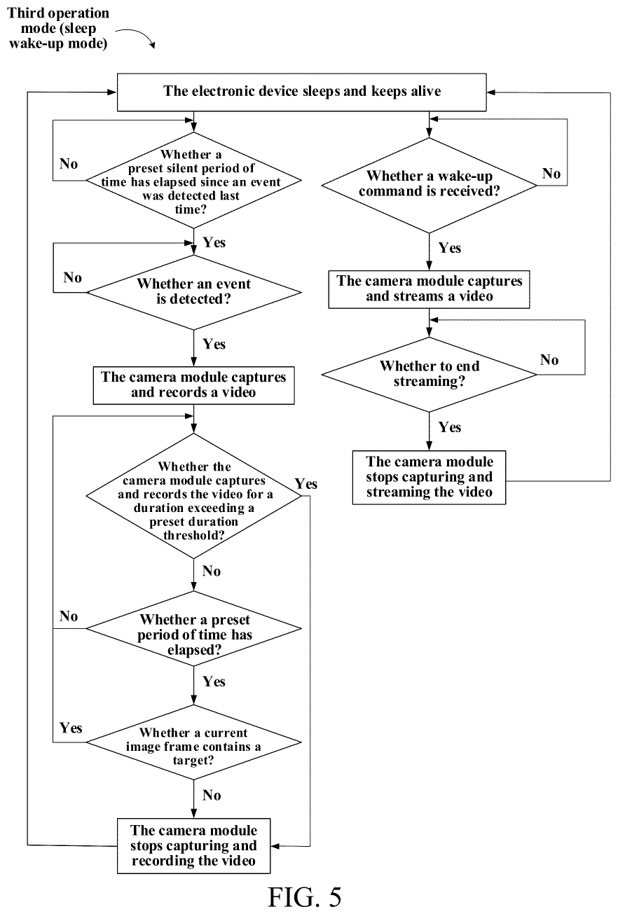

As an example, FIG. 5 illustrates a process of operating the electronic device 100 in the third operation mode. In this case, the electronic device 100 does not support pre-roll, but supports passive wake-up by event and remote active wake-up. Specifically, the electronic device 100 is in the fifth state by default, i.e., the electronic device 100 sleeps and keeps alive. On the one hand, upon an event is detected during the non-silent period of time, the camera module starts to capture and record a video. Next, when the camera module captures and records the video for a duration not exceeding the preset duration threshold, whether a current image frame captured by the camera module contains a target is determined once every preset period of time. If the target is contained, the camera module continue to capture and record the video. If the target is not contained, the camera module stops capturing and recording the video. When the camera module captures and records the video for a duration exceeding the preset duration threshold, the camera module also stops capturing and recording the video. On the other hand, upon a wake-up command is received, for example, a user's viewing request is received, the camera module starts to capture and stream a video. Once it is determined to end streaming, for example, a user's request to end viewing is received, the camera module stops capturing and streaming the video.

### (4) Fourth Operation Mode (Power Saving Mode)

When the electronic device 100 is operated in a fourth operation mode, the electronic device 100 may be operated by: causing the electronic device to be in a seventh state by default, wherein in the seventh state, the camera module 104 is deactivated, the pre-roll module 106 is deactivated, and event detection is not performed (for example, the event detection module 108 is deactivated); causing the electronic device 100 to enter an eighth state from the seventh state in response to a wake-up command from the user equipment 150 communicating with the electronic device 100 being received, wherein in the eighth state, the camera module 104 is activated to capture a video, and the video captured by the camera module 104 is streamed to the user equipment 150 for viewing by a user. The embodiments regarding the wake-up command are similar to the above, which will not be repeated here.

In other words, in the fourth operation mode, the electronic device 100 does not support pre-roll or passive wake-up by event, but supports remote active wake-up. Since the electronic device 100 is maintained in the sleep keep-alive state unless awakened actively by the user in the fourth operation mode, this fourth operation mode has lower power consumption than the above three modes, and is also referred to as power saving mode herein.

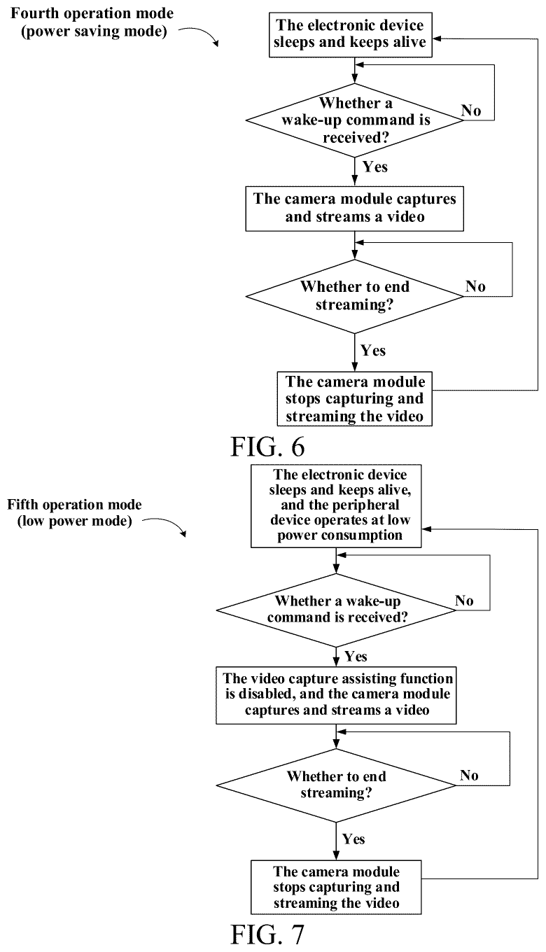

As an example, FIG. 6 illustrates a process of operating the electronic device 100 in the fourth operation mode. Specifically, the electronic device 100 is in the seventh state by default, i.e., the electronic device 100 sleeps and keeps alive. Upon a wake-up command is received, for example, a user's viewing request is received, the camera module starts to capture and stream a video. Once it is determined to end streaming, for example, a user's request to end viewing is received, the camera module stops capturing and streaming the video.

### (5) Fifth Operation Mode (Low Power Mode)

When the electronic device 100 is operated in a fifth operation mode, the electronic device 100 may be operated by: causing the electronic device 100 to be in a ninth state by default, wherein in the ninth state, the camera module 104 is deactivated, the pre-roll module 106 is deactivated, event detection is not performed (for example, the event detection module 108 is deactivated), and a peripheral device 116 of the electronic device 100 is operated in a low power consumption mode (for example, an output volume of a speaker is turned down and the like); causing the electronic device 100 to enter a tenth state from the ninth state in response to a wake-up command from the user equipment 150 communicating with the electronic device 100 being received, wherein in the tenth state, the camera module 104 is activated to capture a video with a video capture assisting function being disabled (for example, the supplementary lighting module 118 is deactivated), and the video captured by the camera module 104 is streamed to the user equipment 150 for viewing by a user. The embodiments regarding the wake-up command are similar to the above, which will not be repeated here.

In other words, in the fifth operation mode, the electronic device 100 does not support pre-roll or passive wake-up by event, but supports remote active wake-up. Since the electronic device 100 is maintained in the sleep keep-alive state unless awakened actively by the user in the fifth operation mode, and on the basis of the power saving mode, the video capture assisting function is further disabled and the peripheral device is operated in the low power consumption mode, this fifth operation mode has lower power consumption than the power saving mode, and is also referred to as low power mode herein.

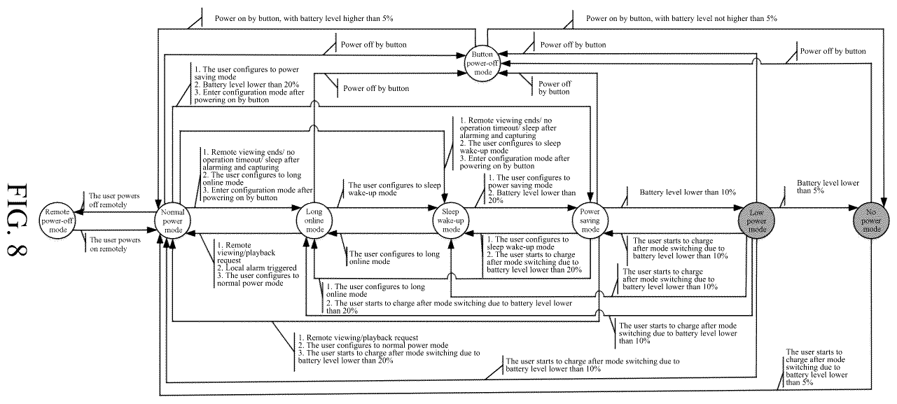

As an example, FIG. 7 illustrates a process of operating the electronic device 100 in the fifth operation mode. Specifically, the electronic device 100 is in the ninth state by default, i.e., the electronic device 100 sleeps and keeps alive, and the peripheral device is operated in the low power consumption mode. Upon a wake-up command is received, for example, a user's viewing request is received, the camera module starts to capture and stream a video, but the video capture assisting function is disabled when capturing the video. Once it is determined to end streaming, for example, a user's request to end viewing is received, the camera module stops capturing and streaming the video.

### (6) Sixth Operation Mode (No Power Mode)

When the electronic device 100 is operated in a sixth operation mode, the electronic device 100 may be operated by: causing the electronic device 100 to be in an eleventh state, wherein in the eleventh state, the camera module 104 is deactivated, the pre-roll module 106 is deactivated, event detection is not performed (for example, the event detection module 108 is deactivated), and response to a wake-up command from the user equipment 150 communicating with the electronic device 100 is not performed (for example, the communication module 114 is deactivated).

In other words, in the sixth operation mode, the electronic device 100 does not support pre-roll, passive wake-up by event, or remote active wake-up. This sixth operation mode is applied to a case where the electronic device 100 substantially has no power, and is also referred to as no power mode herein.

### (7) Seventh Operation Mode (Remote Power-Off Mode)

The electronic device 100 may further be operated by: switching the electronic device 100 to a seventh operation mode in response to a power-off command from the user equipment 150 communicating with the electronic device 100 being received. When the electronic device 100 is operated in the seventh operation mode, the electronic device 100 is deactivated except for allowing the electronic device 100 to communicate with the user equipment 150; the electronic device 100 is switched back to a default operation mode (for example, the first operation mode (long online mode), the second operation mode (normal power mode), the third operation mode (sleep wake-up mode), or the fourth operation mode (power saving mode)), or an operation mode in which the electronic device 100 was operated before being powered off remotely, in response to a power-on command from the user equipment 150 being received. In some examples, it may be preferred to configure the default operation mode as the first operation mode (long online mode).

In other words, in the seventh operation mode, the electronic device 100 does not support pre-roll, passive wake-up by event, or remote active wake-up. In this case, even if the user wants to remotely wake up the electronic device 100, the user will be informed that the electronic device 100 has been powered off and needs to be powered on first. This seventh operation mode is also referred to as remote power-off mode herein.

### (8) Eighth Operation Mode (Button Power-Off Mode)

The electronic device 100 may further be operated by: switching the electronic device 100 to an eighth operation mode in response to a button power-off operation at the electronic device 100. When the electronic device 100 is operated in the eighth operation mode, the electronic device 100 is deactivated; the electronic device 100 is switched back to a default operation mode (for example, the first operation mode (long online mode), the second operation mode (normal power mode), the third operation mode (sleep wake-up mode), or the fourth operation mode (power saving mode)), or an operation mode in which the electronic device 100 was operated before being powered off by button, in response to a button power-on operation at the electronic device 100. In some examples, it may be preferred to configure the default operation mode as the first operation mode (long online mode). This eighth operation mode is also referred to as button power-off mode herein. In the button power-off mode, only powering on by button is supported and remote powering on is not supported.

A mode switching mechanism of the electronic device 100 will be described below with reference to FIG. 8.

In some embodiments, the electronic device 100 is switched from its current operation mode to the fourth operation mode (power saving mode) in response to a battery level of the battery 1022 of the electronic device 100 decreasing to or below a first battery level threshold. In some embodiments, the electronic device 100 is switched from its current operation mode to the fifth operation mode (low power mode) in response to a battery level of the battery 1022 of the electronic device 100 decreasing to or below a second battery level threshold, where the first battery level threshold is higher than the second battery level threshold. In some embodiments, the electronic device 100 is switched from its current operation mode to the sixth operation mode (no power mode) in response to a battery level of the battery 1022 of the electronic device 100 decreasing to or below a third battery level threshold, where the second battery level threshold is higher than the third battery level threshold. In the non-limiting example of FIG. 8, the first battery level threshold is set to 20%, the second battery level threshold is set to 10%, and the third battery level threshold is set to 5%. In some embodiments, after a mode switching occurs due to a decrease in the battery level, the electronic device 100 may be switched back to a previous operation mode, or a default operation mode (for example, the first operation mode (long online mode), the second operation mode (normal power mode), the third operation mode (sleep wake-up mode), or the fourth operation mode (power saving mode)), in response to determining that the electronic device 100 is connected to an external power supply for charging. In some examples, it may be preferred to switch the electronic device 100 back to the previous operation mode, which is beneficial for improving the user experience.

For example, for the normal power mode, long online mode, and sleep wake-up mode, the user may be reminded (for example, by sending a notification to the user equipment 150 via the communication module 114) to switch to the power saving mode when the battery level of the electronic device 100 is less than or equal to 20%. If a configuration command from the user to switch to the power saving mode is not received within a certain period of time (for example, 5 seconds), the electronic device 100 may automatically switch to the power saving mode and may further remind the user to charge the electronic device 100 at the same time. If the user starts to charge the electronic device 100, the electronic device 100 may automatically switch back to the operation mode previously configured by the user. For example, if the electronic device 100 automatically switches to the power saving mode because the battery level is below 20% when it is in the long online mode, then the electronic device 100 may automatically switch back to the long online mode in response to the user starting to charge the electronic device 100.

If the user does not charge the electronic device 100, the electronic device 100 automatically switches to the low power mode when the battery level is less than or equal to 10%. If the user starts to charge the electronic device 100 thereafter, the electronic device 100 may automatically switch back to the operation mode previously configured by the user.

If the user still does not charge the electronic device 100, the electronic device 100 automatically switches to the no power mode when the battery level is less than or equal to 5%. If the user starts to charge the electronic device 100 thereafter, the electronic device 100 may automatically switch back to the operation mode previously configured by the user.

In FIG. 8, descriptions of some mode switching processes have been omitted to make the figure clear and concise, but this does not mean that these mode switching processes are excluded. For example, in a case where it automatically switches back to the operation mode previously configured by the user after charging in the no power mode, only the case where the previously configured operation mode is the normal power mode is depicted, and the cases where the previously configured operation mode is the long online mode, sleep wake-up mode, or power saving mode are omitted. However, this does not mean that the latter three cases are excluded.

Referring to FIG. 8, regarding the switching between the long online mode (first operation mode) and the normal power mode (second operation mode), the electronic device 100 may be switched from the normal power mode (second operation mode) to the long online mode (first operation mode) in response to one of: a command from the user equipment 150 communicating with the electronic device 100 to stop video streaming being received (for example, end of remote viewing); a duration for which no command from the user equipment 150 is received exceeding a preset duration threshold (for example, no operation timeout); determining that a current image frame of the video captured by the camera module 104 does not contain the target (for example, sleeping after alarming and capturing); a configuration command from the user equipment 150 to configure the electronic device to the long online mode (first operation mode) being received; or entering a configuration mode for selecting an operation mode of the electronic device 100 after powering on by button to select the long online mode (first operation mode). The electronic device 100 may also be switched from the long online mode (first operation mode) to the normal power mode (second operation mode) in response to one of: a command from the user equipment 150 to perform video streaming being received (for example, remote viewing/playback request); an event being detected (for example, a local alarm being triggered); or a configuration command from the user equipment 150 to configure the electronic device 100 to the normal power mode (second operation mode) being received.

Regarding the switching between the long online mode (first operation mode) and the sleep wake-up mode (third operation mode), the electronic device 100 may be switched from the sleep wake-up mode (third operation mode) to the long online mode (first operation mode) in response to a configuration command from the user equipment 150 communicating with the electronic device 100 to configure the electronic device 100 to the long online mode (first operation mode) being received. The electronic device 100 may also be switched from the long online mode (first operation mode) to the sleep wake-up mode (third operation mode) in response to a configuration command from the user equipment 150 to configure the electronic device 100 to the sleep wake-up mode (third operation mode) being received.

Regarding the switching between the normal power mode (second operation mode) and the sleep wake-up mode (third operation mode), the electronic device 100 may be switched from the normal power mode (second operation mode) to the sleep wake-up mode (third operation mode) in response to one of: a command from the user equipment 150 communicating with the electronic device 100 to stop video streaming being received (for example, end of remote viewing); a duration for which no command from the user equipment 150 is received exceeding a preset duration threshold (for example, no operation timeout); determining that a current image frame of the video captured by the camera module 104 does not contain the target (for example, sleeping after alarming and capturing); a configuration command from the user equipment 150 to configure the electronic device to the sleep wake-up mode (third operation mode) being received; or entering a configuration mode for selecting an operation mode of the electronic device 100 after powering on by button to select the sleep wake-up mode (third operation mode).

Regarding the switching between the normal power mode (second operation mode) and the power saving mode (fourth operation mode), the electronic device 100 may be switched from the normal power mode (second operation mode) to the power saving mode (fourth operation mode) in response to one of: a configuration command from the user equipment 150 to configure the electronic device to the power saving mode (fourth operation mode) being received; the battery level being lower than 20%; or entering a configuration mode for selecting an operation mode of the electronic device 100 after powering on by button to select the power saving mode (fourth operation mode). The electronic device 100 may also be switched from the power saving mode (fourth operation mode) to the normal power mode (second operation mode) in response to one of: a command from the user equipment 150 to perform video streaming being received (for example, remote viewing/playback request); a configuration command from the user equipment 150 to configure the electronic device 100 to the normal power mode (second operation mode) being received; or the user starting to charge after switching from the normal power mode (second operation mode) to the power saving mode (fourth operation mode) due to the battery level being lower than 20%.

Regarding the switching between the long online mode (first operation mode) and the power saving mode (fourth operation mode), the electronic device 100 may be switched from the power saving mode (fourth operation mode) to the long online mode (first operation mode) in response to one of: a configuration command from the user equipment 150 to configure the electronic device 100 to the long online mode (first operation mode) being received; or the user starting to charge after switching from the long online mode (first operation mode) to the power saving mode (fourth operation mode) due to the battery level being lower than 20%.

Regarding the switching between the sleep keep-alive mode (third operation mode) and the power saving mode (fourth operation mode), the electronic device 100 may be switched from the sleep keep-alive mode (third operation mode) to the power saving mode (fourth operation mode) in response to one of: a configuration command from the user equipment 150 to configure the electronic device to the power saving mode (fourth operation mode) being received; or the battery level being lower than 20%. The electronic device 100 may also be switched from the power saving mode (fourth operation mode) to the sleep keep-alive mode (third operation mode) in response to one of: a configuration command from the user equipment 150 to configure the electronic device 100 to the sleep keep-alive mode (third operation mode) being received; or the user starting to charge after switching from the sleep keep-alive mode (third operation mode) to the power saving mode (fourth operation mode) due to the battery level being lower than 20%.

In each of the long online mode (first operation mode), normal power mode (second operation mode), sleep keep-alive mode (third operation mode), power saving mode (fourth operation mode), low power mode (fifth operation mode), and no power mode (sixth operation mode), it enters the remote power-off mode (seventh operation mode) in response to remote powering off by user, or it enters the button power-off mode (eighth operation mode) in response to powering off by button. In the remote power-off mode (seventh operation mode), it enters a default operation mode (for example, the normal power mode shown in FIG. 8, but it may also be the long online mode or the like) or an operation mode before switching to the remote power-off mode in response to remote powering on by user. In the button power-off mode (eighth operation mode), it enters a default operation mode or an operation mode before switching to the button power-off mode in response to powering on by button. For example, after the powering on by button, it may enter the normal power mode (it may also be the long online mode, or the like) in response to the battery level being higher than 5%, or enter the no power mode in response to the battery level being not higher than 5%. When entering the normal power mode due to the battery level being higher than 5%, it may also automatically switch to the power saving mode due to the battery level being lower than 20%, or automatically switch to the low power mode due to the battery level being lower than 10%.

FIG. 8 is merely an example without any limitation. The electronic device 100 may have some or all of the mode switching mechanisms shown in FIG. 8 or may have a mode switching mechanism not shown in FIG. 8.

Except for the low power mode and the no power mode, all other operation modes may be configured by the user. The user may configure the electronic device 100 to the button power-off mode through a button at the electronic device 100. The user may configure the electronic device 100 to the normal power mode, long online mode, sleep wake-up mode, power saving mode, or remote power-off mode through the user equipment 150 (for example, via an application APP associated with the electronic device 100). These five operation modes respectively correspond to a scenario where the user plugs in and uses the electronic device 100 continuously, a scenario where the user saves power but wants to save videos before and during an event, a scenario where the user saves power and only wants to save a video during an event, a scenario where the user saves power and only wants to actively view on demand at the APP, and a scenario where the user wants to protect privacy and remotely powers off the electronic device 100. Each of the normal power mode, long online mode, sleep wake-up mode, power saving mode, and remote power-off mode, has lower power consumption than the operation mode listed therebefore, allowing for longer usage time in battery-powered scenarios. When the battery level of the electronic device 100 is too low, the electronic device 100 may automatically switch the operation mode to reduce power consumption and extend battery life, and synchronously notify the user to improve the user experience.

In addition, the present disclosure further provides a non-transitory storage medium storing computer-executable instructions thereon. The computer-executable instructions, when executed by one or more processors, cause the one or more processors to perform the method of operating the electronic device 100 according to any one of the above-mentioned embodiments of the present disclosure.

The words “left”, “right”, “front”, “rear”, “top”, “bottom”, “above”, “under”, “upper”, “lower” and the like in the description and the claims, if present, are used for a descriptive purpose and are not necessarily used for describing unchanged relative positions. It should be understood that the words used in such a way are interchangeable in proper circumstances so that the embodiments of the present disclosure described herein, for example, can be operated in other orientations that are different from those shown herein or those described otherwise. For example, when the apparatus in the figure is reversed, the feature originally described as being “above” another feature may now be described as being “below” the other feature. The apparatus may also be oriented in other ways (rotated 90 degrees or in other orientations), and the relative spatial relationship will be explained correspondingly.

In the description and claims, when an element is referred to as being “above”, “attached” to, “connected” to, “coupled” to, or “in contact” with another element, the element may be directly above, directly attached to, directly connected to, directly coupled to, or directly in contact with the other element, or there may be one or more intermediate elements. By contrast, when an element is referred to as “directly above”, “directly attached” to, “directly connected” to, “directly coupled” to, or “directly in contact” with another element, there will be no intermediate element. In the description and claims, a feature being arranged “adjacent” to another feature may refer to the feature having a portion that overlaps with the adjacent feature or a portion located above or below the adjacent feature.

For example, as used herein, the word “exemplary” means “used as an example, instance, or illustration”, and is not intended to be a “model” to be accurately copied. Any implementation exemplarily described herein is not necessarily to be construed as preferred or advantageous over other implementations. In addition, the present disclosure is not limited by any stated or implied theory provided in the technical field, background, summary or detailed description.

As used herein, the word “substantially” means that any minor variation caused by the defect of the design or manufacture, the tolerance of the device or the element, the environmental impact, and/or other factors is included. The word “substantially” also allows for the difference from the perfect or ideal situation caused by the parasitic effect, noise, and other practical considerations that may exist in the actual implementation.

Furthermore, terms like “first” and “second” and so on may also be used herein for a reference purpose only, and thus are not intended for a limitation. For example, the terms “first” “second” and other such numerical terms relating to the structure or element do not imply the sequence or the order unless the context clearly indicates otherwise.

It should be further understood that the word “include/comprise”, when used herein, specifies the presence of stated features, integers, steps, operations, units, and/or components, but do not preclude the presence or addition of one or more other features, integers, steps, operations, units, and/or components, and/or combinations thereof.

In the present disclosure, the term “provide” is used broadly for covering all manners of obtaining the object, therefore “provide an object” includes, but not limited to, “purchase”, “prepare/manufacture”, “arrange/set”, “install/assemble”, and/or “order”the object.

As used herein, the term “and/or” includes any and all combinations of one or more of the listed items associated with it. The terms used herein are only for the purpose of describing specific embodiments and are not intended to limit the present disclosure. As used herein, the singular forms “a” , “an”, and “the” are also intended to include the plural form, unless the context clearly indicates otherwise.

A person skilled in the art should be aware that the boundaries between the foregoing operations is merely illustrative. Multiple operations may be combined into a single operation, a single operation may be distributed in an additional operation, and the operations may be performed at least partially overlapping in time. In addition, alternative embodiments may include a plurality of instances of a particular operation, and the operation order may be changed in other various embodiments. However, other modifications, changes, and replacements are also possible. Aspects and elements of all the embodiments disclosed above may be combined in any way and/or in combination with aspects or elements of other embodiments to provide multiple additional embodiments. Therefore, the description and accompanying drawings are to be regarded as illustrative rather than restrictive.

Although some specific embodiments of the present disclosure have been described in detail through examples, those skilled in the art should understand that the foregoing examples are only for description, but not for limiting the scope of the present disclosure. The embodiments disclosed herein may be arbitrarily combined without departing from the spirit and scope of the present disclosure. Those skilled in the art should also understand that various modifications may be made to the embodiments without departing from the scope and spirit of the present disclosure. The scope of the present disclosure is defined by the attached claims.

1. A method of operating an electronic device, the electronic device comprising a battery, a camera module, and a pre-roll module, the battery being configured to supply power to the electronic device, the camera module being configured to capture a video, the pre-roll module being configured to capture a video at lower power consumption compared to the camera module, wherein the method comprises when operating the electronic device in a first operation mode:
causing the electronic device to be in a first state by default, wherein in the first state, the camera module is deactivated, and the pre-roll module is activated to capture and record a video;
causing the electronic device to enter a second state from the first state in response to an event being detected, wherein in the second state, the camera module is activated to capture and record a video;
determining whether a current image frame of the video captured by the camera module contains a target in response to a preset period of time having elapsed since the event is detected;
causing the electronic device to be maintained in the second state in response to determining that the current image frame of the video captured by the camera module contains the target;
causing the electronic device to enter the first state from the second state in response to determining that the current image frame of the video captured by the camera module does not contain the target.

2. The method according to claim 1, further comprising when operating the electronic device in the first operation mode: storing the video recorded by the camera module and the video of a preset duration recorded by the pre-roll module immediately before the event is detected by means of at least one of local storage or cloud storage.

3. The method according to claim 1, wherein the causing the electronic device to enter a second state from the first state in response to an event being detected comprises:
detecting whether an event of a second type different from a first type occurs in response to an event of the first type being detected, and causing the electronic device to enter the second state from the first state in response to the event of the second type being detected; or
detecting whether an event of a second type different from a first type occurs and detecting whether an event of a third type different from the first type and the second type occurs in response to an event of the first type being detected, and causing the electronic device to enter the second state from the first state in response to the event of the second type being detected and the event of the third type being detected.

4. The method according to claim 3, wherein the event of the first type is a passive infrared event, and the event of the second type and the event of the third type are selected from a group including a motion event and a humanoid event.

5. The method according to claim 1, further comprising when operating the electronic device in the first operation mode, performing at least one of:
activating the camera module to capture a video in response to a wake-up command from a user equipment communicating with the electronic device being received, and streaming the video captured by the camera module to the user equipment for viewing by a user; or
after causing the electronic device to be maintained in the second state in response to determining that the current image frame of the video captured by the camera module contains the target, waiting for a preset period of time to redetermine whether a current image frame of the video captured by the camera module contains the target.

6. (canceled)

7. The method according to claim 1, further comprising when operating the electronic device in a second operation mode:
causing the electronic device to be in a third state by default, wherein in the third state, the pre-roll module is deactivated, the camera module is activated to capture a video, and the most recent video of a preset duration is dynamically cached;
causing the electronic device to enter a fourth state from the third state in response to an event being detected, wherein in the fourth state, the camera module is activated to capture and record a video;
determining whether a current image frame of the video captured by the camera module contains a target in response to a preset period of time having elapsed since the event is detected;
causing the electronic device to be maintained in the fourth state in response to determining that the current image frame of the video captured by the camera module contains the target; or
causing the electronic device to enter the third state from the fourth state in response to determining that the current image frame of the video captured by the camera module does not contain the target.

8. The method according to claim 7, further comprising when operating the electronic device in the second operation mode: storing the video recorded by the camera module and the video dynamically cached immediately before the event is detected by means of at least one of local storage or cloud storage.

9. (canceled)

10. The method according to claim 1, further comprising when operating the electronic device in the second operation mode:
causing the electronic device to be in a third state by default, wherein in the third state, the pre-roll module is deactivated, the camera module is activated to continuously capture and record a video, and the video recorded by the camera module is stored locally;
labeling, in the locally stored video, an image frame corresponding to a moment at which an event is detected to indicate the occurrence of the event in response to the event being detected;
determining whether a current image frame of the video captured by the camera module contains a target in response to a preset period of time having elapsed since the event is detected;
labeling, in the locally stored video, the current image frame to indicate the end of the event in response to determining that the current image frame of the video captured by the camera module does not contain the target.

11. (canceled)

12. The method according to claim 7, further comprising at least one of:
switching the electronic device from the second operation mode to the first operation mode in response to one of: a command from a user equipment communicating with the electronic device to stop video streaming being received, a duration for which no command from the user equipment is received exceeding a preset duration threshold, determining that a current image frame of the video captured by the camera module does not contain the target, a configuration command from the user equipment to configure the electronic device to the first operation mode being received, or entering a configuration mode for selecting an operation mode of the electronic device after powering on by button to select the first operation mode; or
switching the electronic device from the first operation mode to the second operation mode in response to one of: a command from the user equipment to perform video streaming being received, an event being detected, or a configuration command from the user equipment to configure the electronic device to the second operation mode being received.

13. The method according to claim 1, further comprising when operating the electronic device in a third operation mode:
causing the electronic device to be in a fifth state by default, wherein in the fifth state, the camera module is deactivated, and the pre-roll module is deactivated;
causing the electronic device to enter a sixth state from the fifth state in response to an event being detected, wherein in the sixth state, the camera module is activated to capture and record a video;
determining whether a current image frame of the video captured by the camera module contains a target in response to a preset period of time having elapsed since the event is detected;
causing the electronic device to be maintained in the sixth state in response to determining that the current image frame of the video captured by the camera module contains the target;
causing the electronic device to enter the fifth state from the sixth state in response to determining that the current image frame of the video captured by the camera module does not contain the target, or in response to determining that a duration for which the electronic device is maintained in the sixth state exceeds a preset duration threshold.

14. (canceled)

15. The method according to claim 13, further comprising when operating the electronic device in the third operation mode:
causing the electronic device to be maintained in the fifth state for a preset silent period of time after causing the electronic device to enter the fifth state from the sixth state, wherein event detection is not performed during the preset silent period of time;
activating the camera module to capture a video in response to a wake-up command from a user equipment communicating with the electronic device being received during the preset silence period of time, and streaming the video captured by the camera module to the user equipment for viewing by a user.

16. The method according to claim 13, further comprising at least one of:
switching the electronic device from the third operation mode to the first operation mode in response to a configuration command from a user equipment communicating with the electronic device to configure the electronic device to the first operation mode being received; or
switching the electronic device from the first operation mode to the third operation mode in response to a configuration command from the user equipment to configure the electronic device to the third operation mode being received.

17. The method according to claim , further comprising when operating the electronic device in a fourth operation mode:
causing the electronic device to be in a seventh state by default, wherein in the seventh state, the camera module is deactivated, the pre-roll module is deactivated, and event detection is not performed;
causing the electronic device to enter an eighth state from the seventh state in response to a wake-up command from a user equipment communicating with the electronic device being received, wherein in the eighth state, the camera module is activated to capture a video, and the video captured by the camera module is streamed to the user equipment for viewing by a user.

18. The method according to claim 17, further comprising when operating the electronic device in a fifth operation mode:
causing the electronic device to be in a ninth state by default, wherein in the ninth state, the camera module is deactivated, the pre-roll module is deactivated, event detection is not performed, and a peripheral device of the electronic device is operated in a low power consumption mode;
causing the electronic device to enter a tenth state from the ninth state in response to a wake-up command from the user equipment communicating with the electronic device being received, wherein in the tenth state, the camera module is activated to capture a video with a video capture assisting function being disabled, and the video captured by the camera module is streamed to the user equipment for viewing by a user.

19. The method according to claim 18, further comprising when operating the electronic device in a sixth operation mode:
causing the electronic device to be in an eleventh state, wherein in the eleventh state, the camera module is deactivated, the pre-roll module is deactivated, event detection is not performed, and response to a wake-up command from the user equipment communicating with the electronic device is not performed.

20. (canceled)

21. The method according to claim 19, further comprising:
switching the electronic device from its current operation mode to the fourth operation mode in response to a battery level of the battery of the electronic device decreasing to or below a first battery level threshold;
switching the electronic device from its current operation mode to the fifth operation mode in response to a battery level of the battery of the electronic device decreasing to or below a second battery level threshold;
switching the electronic device from its current operation mode to the sixth operation mode in response to a battery level of the battery of the electronic device decreasing to or below a third battery level threshold,
wherein the first battery level threshold is higher than the second battery level threshold, and the second battery level threshold is higher than the third battery level threshold; or
switching the electronic device back to a previous operation mode in response to determining that the electronic device is connected to an external power supply for charging.

22. The method according to claim 1, further comprising:
switching the electronic device to a seventh operation mode in response to a power-off command from a user equipment communicating with the electronic device being received, wherein when the electronic device is operated in the seventh operation mode, the electronic device is deactivated except for allowing the electronic device to communicate with the user equipment;
switching the electronic device back to the first operation mode in response to a power-on command from the user equipment being received.

23. The method according to claim 1, further comprising:
switching the electronic device to an eighth operation mode in response to a button power-off operation at the electronic device, wherein when the electronic device is operated in the eighth operation mode, the electronic device is deactivated; and
switching the electronic device back to the first operation mode in response to a button power-on operation at the electronic device.

24. An electronic device, comprising:
a battery configured to supply power to the electronic device;
a camera module configured to capture a video;
a pre-roll module configured to capture a video at lower power consumption compared to the camera module;
one or more processors; and
a memory storing computer-executable instructions which, when executed by the one or more processors, cause the one or more processors to perform the method of operating an electronic device according to claim 1.

25. A non-transitory storage medium storing computer-executable instructions thereon, the computer-executable instructions, when executed by one or more processors, causing the one or more processor to perform the method of operating an electronic device according to claim 1, wherein the electronic device comprises a battery, a camera module, and a pre-roll module, the battery is configured to supply power to the electronic device, the camera module is configured to capture a video, and the pre-roll module is configured to capture a video at lower power consumption compared to the camera module.
